(19) United States
(12) Patent Application Publication
(10) Pub. No.: US 2016/0018865 A1
(43) Pub. Date: Jan. 21, 2016

(54) AUTOMATICALLY ADJUSTABLE, CHARGE-ONLY, USB ADAPTER

(71) Applicant: SparqEE Technologies, L.L.C., Walnut, CA (US)

(72) Inventors: Christopher Thomas Higgins, Placentia, CA (US); Hardeep Singh Johar, Pasadena, CA (US); Joseph Craig Silva, Grand Terrace, CA (US)

(73) Assignee: SparqEE Technologies, L.L.C., Walnut, CA (US)

(21) Appl. No.: 14/801,955

(22) Filed: Jul. 17, 2015

Related U.S. Application Data
(60) Provisional application No. 62/026,018, filed on Jul. 17, 2014.

(51) Int. Cl. G06F 1/26; G06F 13/40; G06F 1/32; G06F 13/38; G06F 13/42

(52) U.S. Cl. CPC G06F 1/266; G06F 13/385; G06F 13/4221; G06F 1/3212; G06F 13/4077

(57) ABSTRACT

A system and method provides a way to sever the data connection between a USB port and a client device, while still allowing the client device to charge. Typical connections between a client device and a USB port involve a USB cable. However, the device described herein is used in series with the client device and USB port. The device automatically detects the allowed charging current from the USB port and presents that information to the client device. During this exchange, no data transfer is allowed between the client device and USB port in either direction. Once the client device is provided, and charging information presented by the device, the client device begins to charge.

### CROSS REFERENCE OF RELATED APPLICATIONS

The present application claims priority from U.S. Provisional Patent Application Ser. No. 62/026,018 entitled “Automatically Adjustable, Charge-Only, USB Adapter” filed on Jul. 17, 2014, the contents of which are hereby incorporated by reference in its entirety.

### FIELD OF THE INVENTION

This invention generally relates to an automatically adjustable, charge-only, universal serial bus (USB) adapter. More specifically, the invention provides a system and method that severs the data connection between a USB port and a client device while still allowing the client device to charge.

### BACKGROUND

Historically, USB cables and the USB protocol have been used to provide an interconnection between a client device and a USB port to exchange both power and data (data-charging by a host device). Since the launch of USB, at least two things have interfered with the standard. The first is the company Apple®, Inc., and other companies following, using their own protocol to set the device recharge rate, which do not comply with any standardized mechanism for recharging. The second is the ability for unwanted third parties to either place data onto the client device, pull data from the client device, or otherwise harm the client device through the modification of the USB port or any device driving or connected to the USB port.

Some devices currently being sold do provide a charge-only functionality but in a very limited manner. One way current charge-only functionality is provided to client devices is by simply severing the data lines completely, leaving them floating. This methodology is ineffective because newer Apple® products will not accept this as a charging port and thus will not recharge causing recharge failure among a wide range of products.

A second method is to short the data lines as seen by the client device. Although this is effective for most non-Apple® products, for some Apple® products, they will not recharge from this type of port modification.

A third methodology is to provide a voltage reference to the data lines as seen by the client device. Although this is effective for Apple® devices, it effectively hardwires one single recharge rate for Apple® devices irrespective of the actual recharge rate the USB port can support—this can be detrimental to the USB port and potentially cause failure to the USB port and underlying hardware.

Situations exist in which a USB port that has been tampered with can inject viruses, steal information, or otherwise cause harm to a device plugged into the USB Port. Situations also exist where data communication between the client device and the USB port is simply not necessary or wanted.

There is currently no single solution to address all USB devices in one single device. Regardless of the reason to remove data communication between the client device and the USB port, the need exists. The system and method of the present invention satisfies this need.

### SUMMARY OF THE INVENTION

According to one preferred embodiment, a system and method provides a way to sever the data connection between a USB port and a client device, while still allowing the client device to charge. Typical connections between a client device and a USB port involve a USB cable. However, the device described herein is used in series with the client device and USB port. The device automatically detects the allowed charging current from the USB port and presents that information to the client device. During this exchange, no data transfer is allowed between the client device and USB port in either direction. Once the client device is provided, and charging information presented by the device, the client device begins to charge.

According to another preferred embodiment, the device connects between standard USB ports, having a standard USB type-A female port, which allows connection from a client device and a standard USB type-A male port, which allows connection to a USB port.

According to other preferred embodiments, the system can exist within a full USB cable, adapter, hub, or other USB based charging device.

According to yet another embodiment, the device operates as soon as it is plugged into a USB port. When the device is plugged into a USB port, it presents information to the client device regarding the available charging speed of the USB port without allowing data to pass to or from the USB port and the client device. Since various charging profiles exist in order to maximize the charging rate, therefore the system may present various profiles to the client device.

### BRIEF DESCRIPTION OF THE DRAWINGS

FIG. 1 is a high-level block and flow diagram depicting the system connection according to one embodiment; and

FIG. 2 is a block diagram illustrating detailed flow and steps performed according to the embodiment of FIG. 1 in block format.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

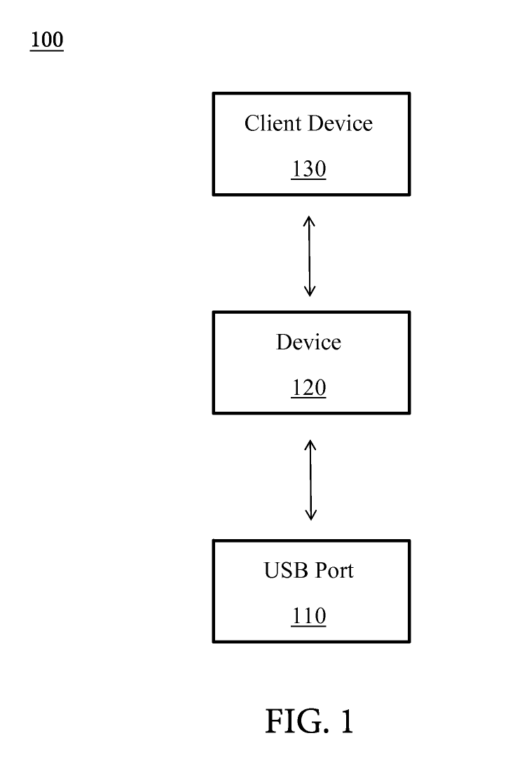

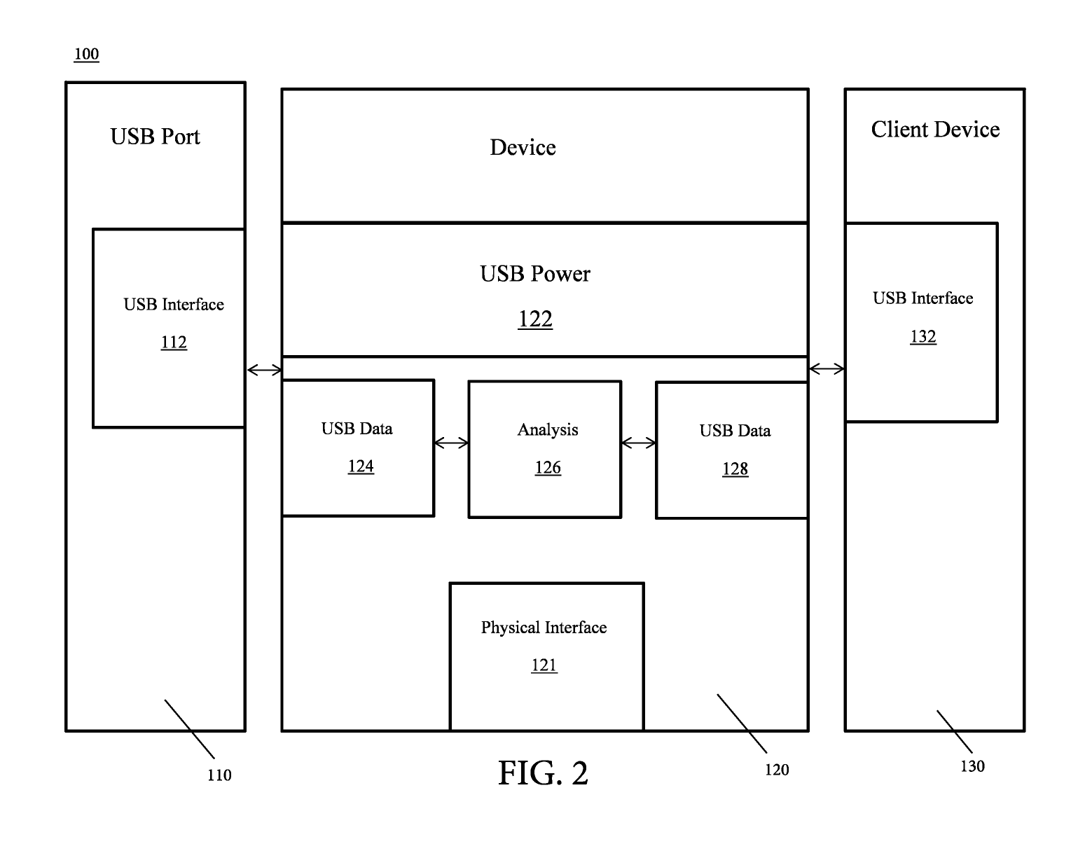

The system and method described herein provides an automatically adjustable, charge-only, universal serial bus (USB) adapter in accordance with preferred embodiments of the present invention and is illustrated in FIGS. 1-2 wherein like reference numerals are used throughout to designate like elements. A listing of the reference numerals follows:
100 overall view of the system
110 a device housing a standard port
112 a physical interface used to exchange data and power
120 an automatically adjustable, charge-only, USB adapter
121 a human machine interface
122 a gated power channel within the device
124 an input/output block within the device
126 a processing block within the device
128 an input/output block within the device
130 a client device connected to the invention
132 a physical interface used to exchange data and power

FIG. 1 depicts a high-level block diagram of a system in which the client device 130 is connected to the adapter device 120, which is connected to the USB port 110. In one embodiment, a way of connecting these devices together is through the use of a generic USB cable providing complete pass-through coupling, but the connection can also happen without the USB cable and just the adapter device 120. If a USB cable is utilized, it can be placed either between the client device 130 and adapter device 120, or between the adapter device 120 and USB port 110. The adapter device 120 may also be expanded to a full cable, included in a hub, as a lager adapter, into a power source, or any USB-based charging device. Due to the standard nature of type-A USB adapters, one embodiment connects the client device 130 to a compatible USB cable, and the type-A male end of that compatible USB cable is connected to the Device 120. Then the adapter device 120 is directly connected to a USB port 110.

FIG. 2 depicts a block diagram and the underlying features of one embodiment. Once the USB port 110 is connected using its physical USB interface 112 to the adapter device 120, the power may pass through the adapter device 120, through the USB power stage 122. The data lines, on the other hand, are analyzed first by connecting directly to the USB data stage 124. Output from the USB data stage 124 may be analyzed through the analysis stage 126. The analysis stage 126 may provide information to the USB data stage 128. Then the USB data stage 128 may depict what is presented to the client device 130 based on the information provided by previous stages. The client device 130 may also use its physical USB interface 132 to connect to the adapter device 120. As descried, since the interfaces are standard USB, intermediary pass-through cables may be utilized without affecting operation.

In one embodiment, the interface between the USB port 110 and adapter device 120, as well as the interface between the client device 130 and the adapter device 120, may be accomplished using standard USB cables. With respect to the USB power stage 122, the adapter device 120 may use the standard USB connections of drain voltage (VDD) and ground (GND), which are the power and ground lines respectively. These lines may also be used to power the adapter device 120. The standard USB connections of D+ and D− are the data lines. The data lines from the USB port 110 are brought into the adapter device 120 as USB data 124. The adapter device 120 uses the analysis stage 126 to determine the recharging characteristics of the USB port 110. This analysis includes both standard and non-standard USB ports 110, including Apple® devices. The information that is discovered during the analysis stage 126 may then be presented to the client device 130 through the USB data stage 128 of the adapter device 120. This design may allow the removal of the data lines and any data communication between the USB port 110 and the client device 130 without effecting charging speed that the client device 130 is able to achieve and the USB port is able to supply.

### Components and Steps of the Embodiments

In one embodiment, the details pertaining to the adapter device 120 may rely on the fact that the adapter device 120 provides an automatically-adjustable, charge-only service by removing all data communication between client device 130 and USB port 110 while still providing the client device 130 full speed charging capabilities of the USB port 110.

### USB Port

The USB port 110 may comprise any standard device whose USB hardware will be used to recharge a client device 130. Typical USB ports provide power to client devices, but can also provide data communication depending on the type of device it is. This USB port 110 is a representation of all possible USB hardware used for this purpose.

### USB Interface

The USB interface 112 may comprise the specific USB plug that a USB cable would plug into or that the adapter device 120 would plug into. For standard type-A USB connectors, a four wire connector may be presented with VDD, GND, D+, D− being power, ground, and two data lines respectively.

### Adapter Device

In one embodiment, the adapter device 120 may comprise two connectors, which feed the USB data block 124 and USB data block 128, as well as the USB power block 122. In the current embodiment, the adapter device 120 may present a female type-A USB connector to the client device 130 and plugs into the USB port 110 using a male type-A USB connector. When the adapter device 120 is plugged into a USB port 110, the two power pins (VDD and GND) may be passed through and presented without interruption to the client device 130 through the USB power block 122. The data pins (D+ and D−) however may be routed directly through to the USB data block 124 and stopped there. Following the analysis of the USB data by the analysis block 126, the resultant output may be available to the client device 130 through the USB data block 128, which provides the data pins (D+ and D−) to the client device 130. The information provided to the client device 130 informs the client device 130 of the recharge rate that is available to be achieved over the power pins (VDD and GND) from the USB port 110.

By analyzing the data passed from the data pins of the USB port 110 to the USB data block 124, which feeds inputs to the analysis block 126, the adapter device 120 uses the analysis block 126 to determine the correct charging rate that the USB port 110 can support and presents that information to the client device 130 through the USB data block 128. The adapter device 120 may execute this automatic procedure as soon as the adapter device 120 is connected to the USB port 110.

### Physical Interface

The physical interface block 121 demonstrates that the adapter device 120 can include additional features and triggers based on the external interface in one embodiment. These additional features and triggers can expand on the base adapter device 120 to include USB storage, voltage, current, and power measurement, pass-through mode, visual activity indication, a nightlight, and additional custom functions. USB storage adds data storage functionality. Measurement capabilities can be provided for voltage, current, and power measurement tracked over time. Pass-through mode allows data through the device. A visual activity indicator may provide visual indication of an event known or provided to the adapter device 120, whereas a nightlight function may comprise a light sourced from the device.

### USB Power

The USB Power block 122 demonstrates that the USB power lines (VDD and GND) pass through from the USB port 110 to the client device 130 without modification within or by the adapter device 120 but may switch the power on or off. Although the adapter device 120 does use power attained from the same power lines to power its own operation, it does not modify the voltage passed through as it does to the data lines.

### USB Data

The USB data block 124 is the point at which the adapter device 120 may sever the data lines (D+ and D−) from the USB port 110. The USB data block 124 does this so that no communication may exist between the USB port 110 and the client device 130. Within this block, the data lines may be read and information regarding the characteristics of the USB port 110 may be provided to the analysis block 126.

### Analysis

Following the USB data block 124, the analysis block 126 may decipher, interpret, and convert the information passed from the USB port 110 through to the data output block so that it may be presented to the client device 130. This analysis may include the charge rate permitted by the USB port 110, based on the information the data input block deciphered. Once the rate is determined, that information is provided to the USB data block 128.

### USB Data

The USB Data block 128 may connect a new set of data lines (D+ and D−) to the client device 130 and present the rate information deciphered in the analysis block 126 to the client device 130 over those data lines. This information may be used by the client device to set its own charging rate to match that of the USB port 110 available charging rate.

### Client Device

The client device 130 may comprise any device that utilizes USB as a mechanism to charge and or communicate information between a client device 130 and any compatible USB port 110. Typical client devices may include, by way of example and not by way of limitation, phones, tablets, portable media players, or any other battery operated devices that connect via USB. Irrespective of the purpose the client device 130 fulfils, if it connects via USB in order to recharge, it is applicable as the adapter device 120 would provide the capability to sever data communications while allowing charging.

### USB Interface

The USB Interface 132 may be the specific USB plug that a USB cable would plug into or that the adapter from which the device 120 would accept a connection. For standard type-A USB connectors, a four-wire connector may be present with VDD, GND, D+, D− being power, ground, and two data lines respectively.

### Additional Features

Additional features can be optionally added to the external encryption device 140 to create a more unique and user-friendly experience providing advantages in a variety of situations.

Indication and sensory output: An indicator can be added to the device without changing functionality to indicate if power is on or off, to indicate if data is being attempted to transmit, to indicate the charge rate, voltage and accumulated charge transferred, or other indications. This capability can be provided by any sensory output mechanism including an organic light emitting diode/liquid crystal display (OLED/LCD) screen a light emitting diode (LED), buzzer, vibrator, among other mechanisms. These indicators do not change or modify the functionality of the underlying adapter device 120 described herein.

Buttons, switches, and sensory input: Buttons, switches, an accelerometer, a visual detector, an auditory detector, or other methodologies of providing sensory input to the adapter device 120 can be used to modify the adapter device 120. These sensory mechanisms can be utilized to enable or disable data lines from flowing between the USB port 110 and client device 130, modify the charging rate, turn on or off the device, or provide other input to the device. These sensory inputs do not change or modify the functionality of the underlying adapter device 120 described herein.

Connector types: Although USB is described herein, any technology or standard that utilizes both power and data communication through a single cable can be split as described to provide a recharging mechanism without allowing data to pass-through.

Switched power and ground: Whether automatic or manual, power from the USB port 110 to client device 130 can be switched (turned on or off) in order to control the charging of the client device 130 directly. This does not change or modify the functionality of the underlying adapter device 120 described herein.

Processing: The adapter device 120 can consist of a variety of technologies to provide an automatically adjustable mechanism to effectively remove the data communication. In one embodiment, the processing within the adapter device 120 utilizes a microcontroller, but discrete or other active components can be utilized as well to achieve the same result.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A system for charging a device, comprising:
a physical interface capable of connection between a chargeable client device and data-port of a host device, the host device and client device capable of exchanging data;
an adapter included with the physical interface capable of:
(a) detecting an allowed charging current from the port of the host device;
(b) presenting the allowed charging current to the client device;
(c) removing data transfer capability through the physical interface; and
(d) passing through charge to the client device based on the allowed charging current.

2. The system of claim 1, wherein the port comprises a universal serial bus (USB) port.

3. The system of claim 2, wherein the adapter comprises a USB adapter.

4. The system of claim 1, wherein the adapter comprises a gated power channel.

5. The system of claim 1, wherein the adapter comprises an input/output block.

6. The system of claim 1, wherein the adapter comprises a processing block.

7. The system of claim 1, wherein the adapter comprises a full cable, included in a hub.

8. The system of claim 1, wherein the adapter comprises a data stage that detects and analyzes the allowed charging current.

9. The system of claim 1, wherein the adapter comprises two connecters that feed two USB data blocks and a USB power block.

10. The system of claim 1, wherein the adapter further comprises a sensory output.

11. The system of claim 10, wherein the sensory output further comprises an indicator to indicate one or more indications selected from one or more of the following consisting of:
whether power is on or off; whether data transmission is being attempted, voltage, charge rate and accumulated charge transferred.

12. The system of claim 10, wherein the sensory output comprises one or more of the following types of sensory output consisting of: an organic light emitting diode/liquid crystal display (OLED/LCD) screen, light emitting diode, buzzer, and vibrator.

13. The system of claim 1, wherein the adapter further comprises a sensory input that is used to modify functionality of the adapter.

14. The system of claim 13, wherein the sensory input further comprises one or more sensory inputs selected from one or more of the following consisting of: a button, a switch, an accelerometer, a visual detector, and an auditory detector.

15. The system of claim 13, wherein the functionality further comprises one or more of the following types functionality consisting of: to enable or disable data lines from flowing between the USB port and client device, to modify the charging rate, and to turn on or off the device.
